(19) United States
(12) Patent Application Publication
(10) Pub. No.: US 2011/0096209 A1
(43) Pub. Date: Apr. 28, 2011

(54) SHADING CORRECTION METHOD, SHADING-CORRECTION-VALUE MEASURING APPARATUS, IMAGE CAPTURING APPARATUS, AND BEAM-PROFILE MEASURING APPARATUS

(75) Inventor: Shin Hotta, Tokyo (JP)

(73) Assignee: SONY CORPORATION, Tokyo (JP)

(21) Appl. No.: 12/907,096

(22) Filed: Oct. 19, 2010

(30) Foreign Application Priority Data
Oct. 28, 2009 (JP) 2009-248277

(51) Int. Cl. H04N 9/64

(52) U.S. Cl. 348/251; 348/E09.037

(57) ABSTRACT

A shading correction method includes dividing a light receiving region of a solid-state image capturing element, in which pixels including light receiving elements are disposed, into areas; irradiating each of the areas with light, which is emitted from a light source serving as a reference, via an image forming optical system so that a size of a spot of the light corresponds to a size of the area; storing a sensitivity value of each of the areas in an area-specific-sensitivity memory; calculating shading correction values for all of the pixels of the solid-state image capturing element from the sensitivity values; storing the shading correction values for all of the pixels in a correction-value memory; and correcting signals of the individual pixels, which have been obtained using image capture by the solid-state image capturing element, using the corresponding shading correction values for the individual pixels.

### BACKGROUND OF THE INVENTION

1. Field of the Invention

The present invention relates to a shading correction method, a shading-correction-value measuring apparatus, an image capturing apparatus, and a beam-profile measuring apparatus, and, in particular, to a technology for performing shading correction with a very high accuracy.

2. Description of the Related Art

Various types of apparatuses that measure beam profiles, such as intensities of light beams such as laser light beams, which are called beam-profile measuring apparatuses, have been proposed and commercially available.

In Japanese Unexamined Patent Application Publication No. 2002-316364, one configuration example of a beam-profile measuring apparatus is described. In the beam-profile measuring apparatus described in Japanese Unexamined Patent Application Publication No. 2002-316364, pinholes are provided so as to face a beam, and a photoelectric conversion element is provided ahead of the pinholes. The beam-profile measuring apparatus measures a profile by scanning the pinholes and the photoelectric conversion element along a cross section of the beam.

In Japanese Unexamined Patent Application Publication No. 7-113686, it is described that a profile such as an intensity of a beam is obtained by scanning knife edges so that the knife edges cross the beam, and by subjecting, to calculation processing such as differentiation, signals that are obtained from a photoelectric conversion element provided ahead of the knife edges.

Furthermore, an apparatus that obtains a beam profile, such as an intensity of a beam, by scanning slits along a cross section of the beam exists, although the apparatus is not described in any document.

As methods different from the above-described methods for performing scanning using a beam and for receiving the beam with a photoelectric conversion element, there are methods for directly forming images of laser light on an image capture face of a solid-state image capturing element that is used for image capture. Also using the methods, profiles such as intensities of light beams can be measured in theory. Methods for directly capturing images of laser light with a solid-state image capturing element will be described below.

FIG. 15 is a diagram illustrating an example of a spot of a laser light beam that is detected by a beam-profile measuring apparatus, in which the example is enlarged. In the example illustrated in FIG. 15, regarding each of a vertical position and a horizontal position, a highest intensity is measured at the center of the spot of the laser light beam, and a decrease in the intensity is measured at the peripheral portion of the spot of the laser light beam.

### SUMMARY OF THE INVENTION

As described in Japanese Unexamined Patent Application Publications No. 2002-316364 and No. 7-113686, in the related art, various types of beam-profile measuring apparatuses have been proposed and commercially available. Beams such as laser light beams can be measured with some degree of accuracy. However, there is a problem that the accuracy of intensities of beams that are measured by the beam-profile measuring apparatuses which have been proposed in the related art is not necessarily high.

More specifically, a measurement accuracy is limited by a processing accuracy at which pinholes, slits, or knife edges were processed. For example, for a method for scanning slits along a cross section of a beam, a configuration is supposed, in which slits having a width of 5 μm are provided, and in which measurement is performed using the slits that are diagonally moved. With this configuration, even when the processing accuracy of the slits is ±0.1 μm, a measurement error is at most ±4%. In order to measure a beam profile of laser light emitted from a laser light source that is used for precise measurement and precise processing, a measurement accuracy of 1% or lower is desired. Accordingly, the measurement accuracy of such the beam-profile measuring apparatuses of the related art is not sufficient.

For this reason, the methods for directly forming images of a beam on an image capture face of a solid-state image capturing element and for directly observing and measuring a beam profile of the beam have been considered. As the solid-state image capturing element, for example, a charge-coupled device (CCD) image sensor or a complementary metal oxide semiconductor (CMOS) image sensor can be applied.

In a case of directly forming images of a beam on a solid-state image capturing element as described above, a spatial resolution is limited by the number of pixels of the solid-state image capturing element. However, in recent years, because the number of pixels of solid-state image capturing elements such as CCD image sensors or CMOS image sensors has increased to several million pixels, the number of pixels does not become a problem. Furthermore, such image sensors are produced using semiconductor processes. Accordingly, the image sensors have an accuracy of the order of 0.01 μm for a pixel size of several micrometers. Thus, spatial errors can almost be neglected.

In contrast, when a configuration in which images of a light beam are formed directly on a solid-state image capturing element is used, factors that may cause a reduction in the measurement accuracy occur due to factors associated with an optical system that is used to form images of a light beam with an image capturing apparatus and so forth. More specifically, factors that may cause a reduction in the measurement accuracy with which a profile is measured are as follows: an optical aberration and a coating distribution that are associated with the optical system used to form images of a light beam with the image capturing apparatus; a fourth-power law associated with CMOS processes; inconsistency in gathering of a light beam with a microlens provided on the solid-state image capturing element; and inconsistency in sensitivity of each pixel that is specific to the solid-state image capturing element. Inconsistency in sensitivity including all of the factors given above is referred to as “shading” in the present specification. Shading also depends on the type of optical system or image sensor. However, shading causes inconsistency in sensitivity that can be typically represented as a value which ranges from the order of several percent to the order of several tens percent. When measurement is performed with a measurement accuracy of 1% or lower, it is necessary to remove shading. Image correction for removing shading is referred to as “shading correction” in a description given below.

Note that, in the related art, various types of technologies for performing shading correction have been proposed and commercially available. However, for measurement of an intensity of light with a measurement accuracy of 1% or lower as described above, the accuracy of shading correction in the related art is not sufficient. For example, if light having a uniform intensity can be caused to enter all of pixels that are provided in an image capture element, shading correction values for the individual pixels can be calculated in accordance with a state in which the intensity of the light is detected. However, in reality, it is difficult to prepare a high-accuracy light source capable of causing light, which has characteristics that a percentage of a distribution of the intensity of the light is equal to or lower than 1% and the distribution is uniform, to enter.

Furthermore, in the description given above, in order to easily describe the necessity of performing shading correction with a high accuracy, a beam-profile measuring apparatus is described by way of example. Shading correction is a technology that is important in performing image capture using an image capturing apparatus with a high accuracy. Accordingly, even using an image capturing apparatus in which a solid-state image capturing element is used, such as a video camera or a still camera, similar shading correction is necessary in order to perform image capture with a high accuracy.

The present invention has been made in view of such circumstances. It is desirable to perform shading correction with a high accuracy when image capture is performed using a solid-state image capturing element.

According to an embodiment of the present invention, there is provided a shading correction method. In the shading correction method, a light receiving region of a solid-state image capturing element, in which pixels including light receiving elements are disposed, are divided into areas. Each of the division areas is irradiated with light, which is emitted from a light source serving as a reference, via an image forming optical system so that a size of a spot of the light corresponds to a size of the area. A sensitivity value of each of the areas that have been irradiated with the light is stored in an area-specific-sensitivity memory. Shading correction values for all of the pixels of the solid-state image capturing element are calculated from the sensitivity values that are stored in the area-specific-sensitivity memory. The calculated shading correction values for all of the pixels are stored in a correction-value memory. Signals of the individual pixels are obtained using image capture by the solid-state image capturing element, and corrected using the corresponding shading correction values for the pixels that are stored in the correction-value memory.

In the shading correction method, the light emitted from the light source serving as a reference is received in each of the areas so that the size of a spot of the light corresponds to the size of the area. A sensitivity value of each of the areas is obtained. Accordingly, the intensities of light detected in the individual areas are the same. Sensitivity values in which a state of shading that occurs in the areas is reflected are detected. Then, shading correction values for all of the pixels are obtained on the basis of the detected sensitivity values of the individual areas. Thus, the shading correction values can be obtained with a high accuracy on the basis of the detected sensitivity values.

According to the embodiment of the present invention, the shading correction values for the individual pixels can be obtained with a high accuracy on the basis of the detected sensitivity values of the individual areas. Shading correction with a high accuracy can be performed on image capture signals that have been obtained by the solid-state image capturing element.

Accordingly, for example, the shading correction method is applied to shading correction for an image capturing apparatus, whereby image capture signals that have been completely subjected to shading correction can be obtained.

Furthermore, for example, the shading correction method is applied to shading correction for an image capturing element included in a beam-profile measuring apparatus, whereby a beam profile can be measured with a very high accuracy.

### BRIEF DESCRIPTION OF THE DRAWINGS

FIG. 1 is a configuration diagram illustrating an example of an overall configuration in an embodiment of the present invention;

FIG. 2 is an explanatory diagram illustrating an example of division of an image capture region of a solid-state image capturing element into areas in the embodiment of the present invention;

FIG. 3 is an explanatory diagram illustrating an overview of signal processing that is performed at a time of measurement of shading in the embodiment of the present invention;

FIG. 4 is an explanatory diagram illustrating an overview of signal processing that is performed at a time of image capture in the embodiment of the present invention;

FIG. 5 is an explanatory diagram illustrating an overview of a process of generating shading correction values in the embodiment of the present invention;

FIG. 6 is an explanatory diagram illustrating an example of a specific area setting in the embodiment of the present invention;

FIG. 7 is an explanatory diagram illustrating an example of an order in which measurement is performed for the areas in the embodiment of the present invention;

FIG. 8 is an explanatory diagram illustrating the process of generating shading correction values with the area setting illustrated in FIG. 6;

FIGS. 9A to 9D are explanatory diagrams illustrating characteristic examples in states of a process of calculating sensitivity values in the embodiment of the present invention;

FIGS. 10A to 10C are explanatory diagrams illustrating detailed examples in states of the process of calculating sensitivity values in the embodiment of the present invention;

FIG. 11 is an explanatory diagram illustrating an example in which the process of calculating sensitivity values is performed for an end in the embodiment of the present invention;

FIGS. 12A to 12C are explanatory diagrams illustrating an example of a process of estimating sensitivity values in a column direction in the embodiment of the present invention;

FIG. 13 is an explanatory diagram illustrating an example (a first example) of a measurement state in a case in which the size of a spot of a laser light beam is larger than the size of the division areas;

FIG. 14 is an explanatory diagram illustrating an example (a second example) of a measurement state in a case in which the size of a spot of a laser light beam is larger than the size of the division areas; and

FIG. 15 is a principle diagram illustrating an example of measurement of a beam profile in the related art.

### DESCRIPTION OF THE PREFERRED EMBODIMENTS

Examples of embodiments of the present invention will be described in the order of section headings as follows.

### 1. Description of One Embodiment

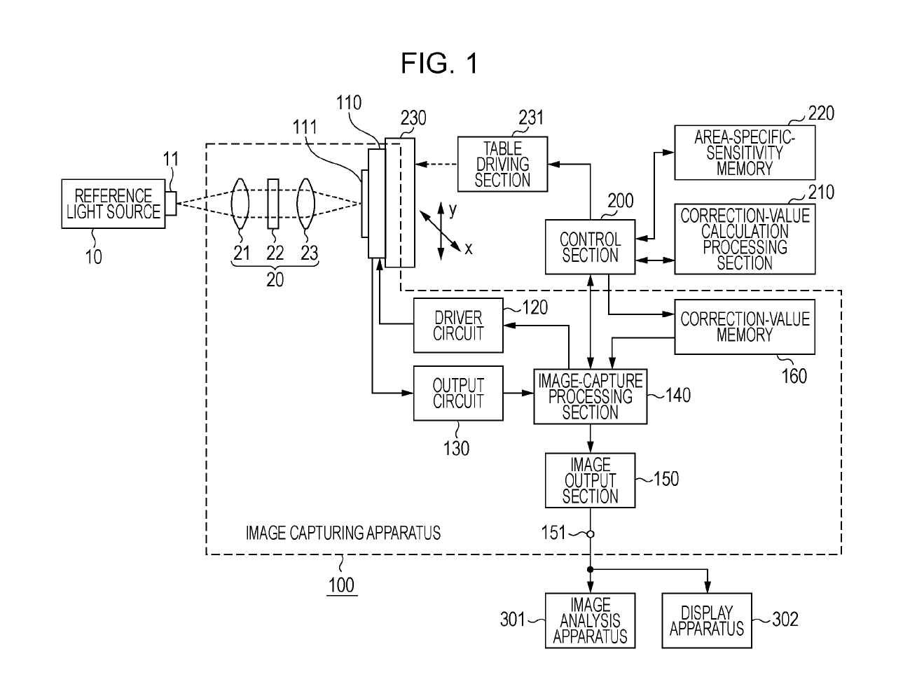

### 1.1 Overall Configuration of System (FIG. 1)

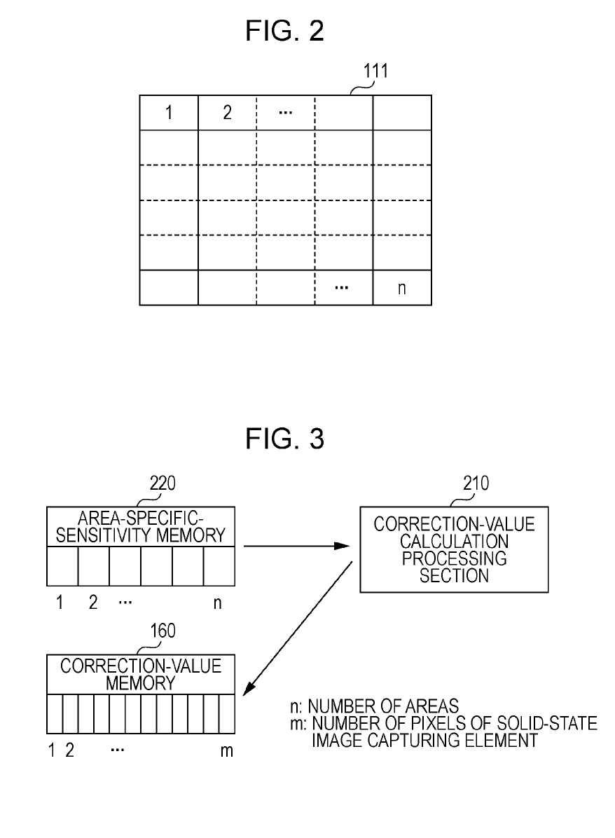

### 1.2 Overview of Process of Obtaining Shading Correction Values (FIGS. 2 and 3)

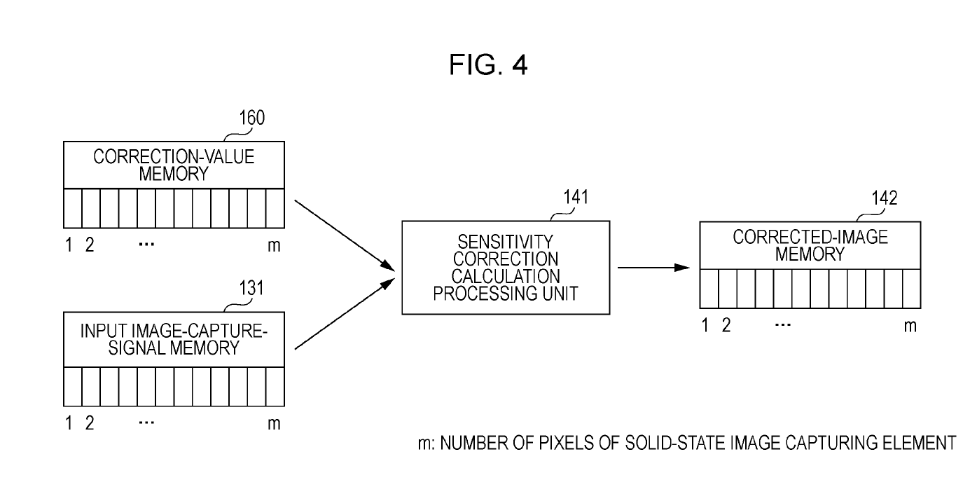

### 1.3 Overview of Process of Performing Shading Correction (FIG. 4)

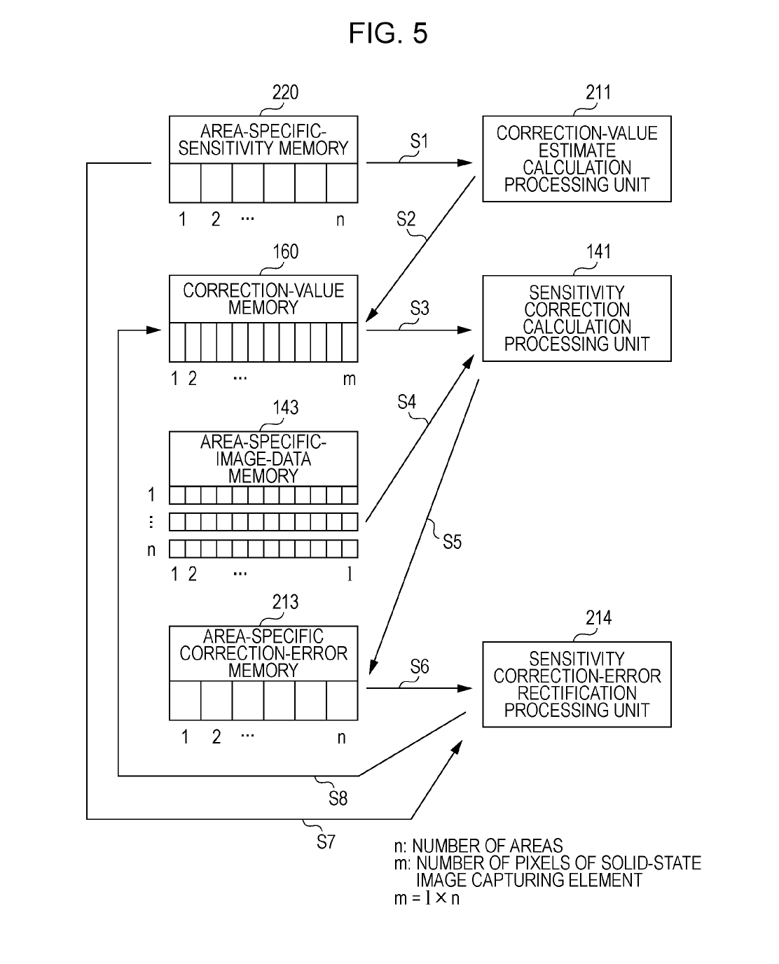

### 1.4 Detailed Description of Process of Generating Shading Correction Values (FIG. 5)

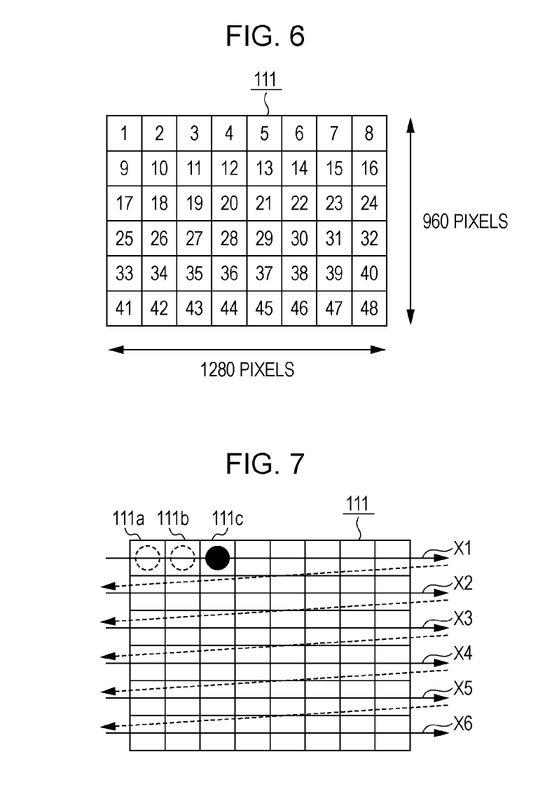

### 1.5 Description of Processing State Based on Specific Area Setting (FIGS. 6 to 8)

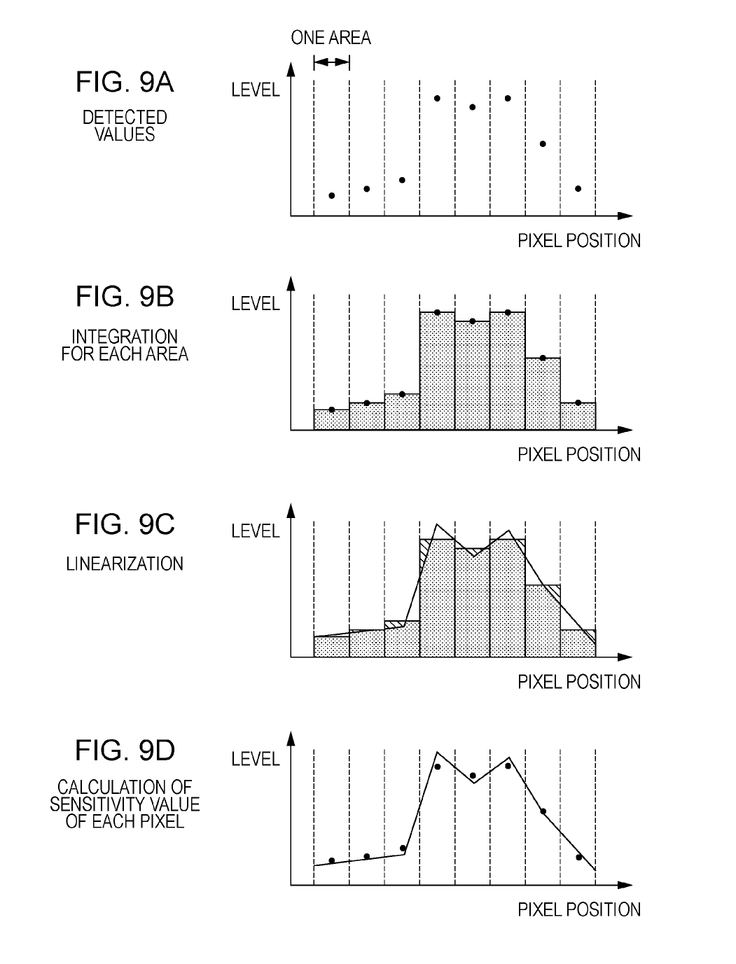

### 1.6 Description of Process of Calculating Sensitivity Values and Shading Correction Values (FIGS. 9A to 9D, FIGS. 10A to 10C, and FIG. 11)

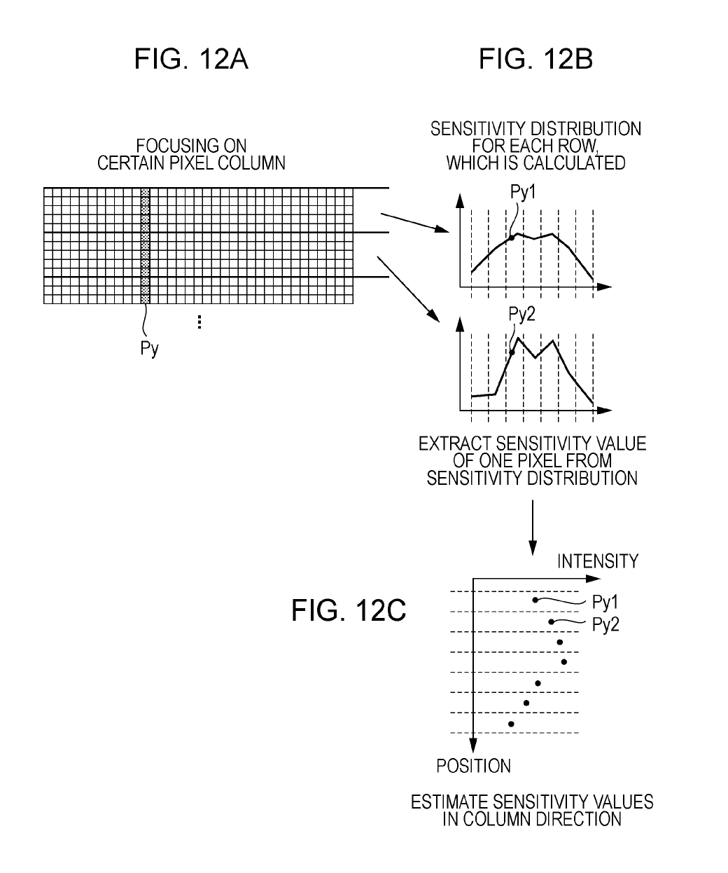

### 1.7 Example of Process of Estimating Sensitivity Values in Column Direction (FIGS. 12A to 12C)

### 1.8 Example of Process of Rectifying Sensitivity Values

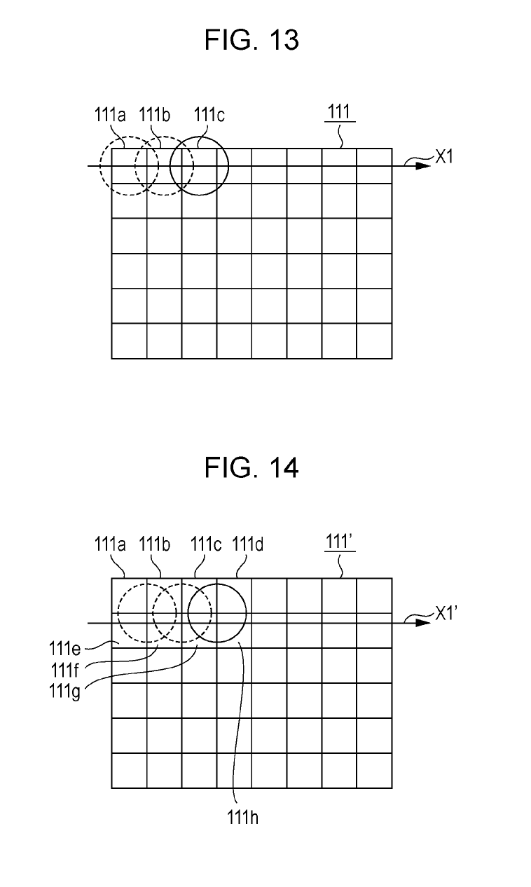

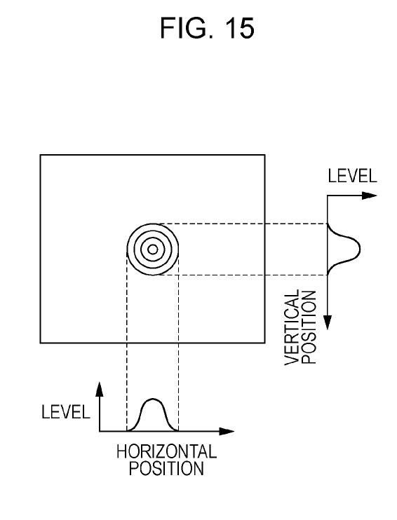

### 2. Description of Modification Examples (FIGS. 13 and 14)

### 1. Description of One Embodiment

Hereinafter, examples of one embodiment of the present invention will be described with reference to FIGS. 1 to 8, FIGS. 9A to 9D, FIGS. 10A to 10C, FIG. 11, and FIGS. 12A to 12C.

### 1.1 Overall Configuration of System

First, an example of an overall configuration of an apparatus in which a process according to the embodiment of the present invention is performed will be described with reference to FIG. 1.

In the embodiment of the present invention, an image capturing apparatus 100 that is configured as a digital camera is prepared, and shading correction is preformed when image capture is performed. An image analysis apparatus 301 and a display apparatus 302 are connected to the image capturing apparatus 100, and the image capturing apparatus 100 is configured to function as a beam-profile measuring apparatus (a measuring system). The image analysis apparatus 301 analyses, using images, a distribution of the intensity of a beam that has been used to capture the images, and measures a beam profile. The display apparatus 302 causes a display to display the captured images (the images that have been obtained by irradiation with the beam).

The configuration illustrated in FIG. 1 is a configuration for obtaining shading correction values for performing shading correction. A control section 200 and peripheral sections therefor that are used to perform shading correction are connected to the image capturing apparatus 100. The control section 200 and the peripheral sections therefor that are used to perform shading correction are configured, for example, using a personal computer apparatus and a program that is implemented in the personal computer apparatus. The personal computer apparatus is connected to the image capturing apparatus 100.

In the image capturing apparatus 100, an optical system 20 that is configured using lenses 21 and 23, a filter 22, and so forth is disposed in front of an image capture region (a face on which an image is formed) 111 of a solid-state image capturing element 110. Laser light that is output from a laser output section 11 of the reference light source 10 is input to the optical system 20. It is only necessary that the reference light source 10 be a light source having a stable output of laser light. Any other light source that outputs light other than laser light may be used if the output amount of the light is stable. Note that, in a case in which a measurement target is laser light when measurement of a beam profile is performed, it is preferable that the wavelength of the laser light which is output by the reference light source 10 and a numerical aperture on the face, on which an image is formed, of the solid-state image capturing element 110 be made to coincide with those of the measurement target.

The image capturing apparatus 100 is placed on an XY table 230. A configuration is provided, in which the image capturing apparatus 100 can be moved in the horizontal direction (an X direction) and the vertical direction (a Y direction) of the image capture region 111 of the solid-state image capturing element 110 included in the image capturing apparatus 100. The image capturing apparatus 100 is moved using the XY table 230, whereby a position, at which the image capture region 111 is to be irradiated with laser light emitted from the reference light source 10, on the image capture region 111 of the solid-state image capturing element 110 can be changed. In other words, the XY table 230 functions as a movement member for light emitted from the reference light source 10. The XY table 230 is moved in the X and Y directions by being driven by a table driving section 231 in accordance with an instruction that is provided by the control section 200. The details of a driving mechanism are not described. However, driving mechanisms having various types of configurations can be applied if the driving mechanisms can realize movement on an area-by-area basis.

Regarding the solid-state image capturing element 110 included in the image capturing apparatus 100, a predetermined number of pixels (light receiving elements) are disposed in the horizontal and vertical directions in the image capture region 111. For example, a CCD image sensor or a CMOS image sensor can be applied as the solid-state image capturing element 110.

Regarding the solid-state image capturing element 110, image light is received in the image capture region 111 via the optical system 20. The image light is converted into image capture signals on a pixel-by-pixel basis, and the image capture signals are output from an output circuit 130. The image capture signals, which have been output from the output circuit 130, are supplied to an image-capture processing section 140. The image-capture processing section 140 performs various types of correction and conversion on the image capture signals to obtain a predetermined image signal. The obtained image signal is output from an image output section 150 to the outside via an image-signal output terminal 151. The image analysis apparatus 301 and the display apparatus 302 are connected to the image-signal output terminal 151.

An image capture operation that is performed in the solid-state image capturing element 110 is performed in synchronization with a drive pulse that is supplied from a driver circuit 120 to the solid-state image capturing element 110. Output of the drive pulse from the driver circuit 120 is performed in accordance with control that is performed by the image-capture processing section 140.

A correction-value memory 160 is connected to the image-capture processing section 140. A process of correcting the image capture signals on a pixel-by-pixel basis is performed using shading correction values that are stored in the correction-value memory 160. Shading correction values are stored in the correction-value memory 160. Storage of the shading correction values in the correction-value memory 160 is performed in accordance with control that is performed by the control section 200. In the image-capture processing section 140, each of pixel values of the image capture signals that have been supplied from the solid-state image capturing element 110 is multiplied by the shading correction value for a corresponding one of the pixels, thereby converting each of the image capture signals into an image capture signal having a pixel value that has been subjected to shading correction.

Next, a configuration, which is provided on the control section 200 side, for performing shading correction will be described.

The control section 200 can read the image capture signals that have been supplied to the image-capture processing section 140. Sensitivity values that are specific to individual areas are generated from the image capture signals that have been read. The image-capture processing section 140 causes an area-specific-sensitivity memory 220 to store the sensitivity values. Shading correction values are generated on a pixel-by-pixel basis by a correction-value calculation processing section 210 using the sensitivity values of the individual areas that are stored in the area-specific-sensitivity memory 220. The control section 200 causes the correction-value memory 160, which is provided on the image capturing apparatus 100 side, to store the generated shading correction values in accordance with control that is performed by the control section 200.

### 1.2 Overview of Process of Obtaining Shading Correction Values

Next, a process of generating shading correction values that are to be stored in the correction-value memory 160 will be described with reference to FIGS. 2 and 3.

In this example, as illustrated in FIG. 2, the image capture region 111 of the solid-state image capturing element 110 is divided in units of predetermined numbers of pixels into a plurality of areas so that the division areas have a mesh form. In other words, the image capture region 111 is divided into a predetermined number of areas in the horizontal direction (the transverse direction in FIG. 2) and divided into a predetermined number of areas in the vertical direction (the longitudinal direction in FIG. 2), thereby dividing the image capture region 111 into n areas (where n is any integer). The numbers of pixels in the individual division areas are the same. A specific example of the number of divisions will be described below. Note that each of the division areas has a size corresponding to the size of a spot of laser light that is emitted from the reference light source 10 and that reaches the image capture region 111. More specifically, the size of each of the division areas is a size with which reception of laser light inside one area can be realized. However, as described below, all laser light not necessarily enters the inside of one area.

After the image capture region 111 is divided into a plurality of areas as described above, as shown using the overview illustrated in FIG. 3, the image capture signals that have been detected from the pixels provided in the individual areas are integrated on an area-by-area basis, thereby obtaining integral values. The integral values are stored, in the area-specific-sensitivity memory 220, as sensitivity values that are specific to the individual areas. When the number of areas is set to be n, the area-specific-sensitivity memory 220 is a memory having n storage regions.

A process of detecting sensitivity values that are specific to the individual areas is performed in a state in which, using movement with the XY table 230, the individual areas are irradiated with laser light emitted from the reference light source 10. In other words, when the image capture region 111 is divided into n areas, an irradiation position at which an area is irradiated with the laser light emitted from the reference light source 10 is moved (n−1) times, thereby sequentially irradiating the centers of the individual areas with the laser light emitted from the reference light source 10. A process of setting the irradiation position is performed, for example, in accordance with control that is performed by the control section 200. Then, an area, among the areas, that has been located at the irradiation position is irradiated with the laser light. An integral value of the image capture signals that have been obtained in the area is obtained. The integral value is divided, for example, by the number of pixels provided in the area, thereby obtaining a value, and the value is stored as a sensitivity value of the area in the corresponding storage region of the area-specific-sensitivity memory 220.

Note that, in an ideal state in which no shading occurs in the image capturing apparatus 100, image capture is performed in a state in which all of the areas are irradiated with the same laser light. Accordingly, all of the sensitivity values that are stored in the area-specific-sensitivity memory 220 are the same for all of the areas. In reality, shading occurs due to various factors associated with the optical system and so forth, and the sensitivity values of the individual areas, which are stored in the area-specific-sensitivity memory 220, are different from one another. In this example, the differences among the sensitivity values are corrected, and shading correction is performed.

When the sensitivity values are stored in all of the storage areas of the area-specific-sensitivity memory 220, a process of calculating shading correction values on a pixel-by-pixel basis from the sensitivity values that have been obtained on an area-by-area basis is performed by the correction-value calculation processing section 210. In the process of calculating shading correction values on a pixel-by-pixel basis, values of the individual areas are connected to each other using straight lines or curves, and values of the individual pixels are estimated on the basis of the straight lines or curves that connect the values of the individual areas to each other. In a specific example described below, a process of connecting values of the individual areas to each other using straight lines, and of estimating values of the individual pixels on the basis of the straight lines is used. The shading correction values for the individual pixels that have been obtained in this manner are stored in the correction-value memory 160, and used to correct the image capture signals. Supposing that the number of pixels that are disposed in the image capture region 111 of the solid-state image capturing element 110 is m, the correction-value memory 160 has m storage regions. The shading correction values for the individual pixels are stored in the respective storage regions. Note that each of the shading correction values for the individual pixels is a reciprocal of the corresponding sensitivity value of the pixel.

### 1.3 Overview of Process of Performing Shading Correction

FIG. 4 is a diagram illustrating an overview of a state in which shading correction is performed using the shading correction values stored in the correction-value memory 160.

The individual pixel values of the image capture signals that are stored in an input image-capture-signal memory 131 are multiplied by a sensitivity correction calculation processing unit 141, which is provided in the image-capture processing section 140, by the shading correction values that are stored in the correction-value memory 160 on a pixel-by-pixel basis, thereby obtaining image capture signals that have been subjected to sensitivity correction. The image capture signals that have been subjected to sensitivity correction are stored in a corrected-image memory 142, and supplied from the corrected-image memory 142 to a processing system that is provided at a stage subsequent thereto.

### 1.4 Detailed Description of Process of Generating Shading Correction Values

Next, a detailed flow of the process of generating shading correction values, the overview of the process being described with reference to FIG. 3, will be described with reference to FIG. 5. Here, the flow will be described under the assumption that the number of areas is n as illustrated in FIG. 2. As illustrated in FIG. 5, the correction-value calculation processing section 210 includes a correction-value estimate calculation processing unit 211, an area-specific correction-error memory 213, and a sensitivity correction-error rectification processing unit 214.

As already described, the image capture signals are integrated on an area-by-area basis as illustrated in FIG. 2, thereby obtaining integral values of the image capture signals. The integral values of the image capture signals for the individual areas are divided by the number of pixels included in each of the areas, thereby obtaining sensitivity values of the individual areas. The sensitivity values of the individual areas are stored in the area-specific-sensitivity memory 220. The correction-value estimate calculation processing unit 211 reads the sensitivity value of each of the areas (step S1), and a process of estimating sensitivity values on a pixel-by-pixel basis is performed, thereby obtaining shading correction values. The obtained shading correction values are stored in the correction-value memory 160 (step S2). As the process of estimating sensitivity values, a process of connecting values of the individual areas to each other using straight lines or curves, and of estimating values of the individual pixels on the basis of the straight lines or curves that connect the values of the individual areas is used. The details of the process of estimating sensitivity values will be described below.

The shading correction values stored in the correction-value memory 160 are supplied to a sensitivity correction calculation processing unit 141 (step S3). Image data items (captured image data items) that are specific to the individual areas are also supplied to the sensitivity correction calculation processing unit 141 (step S4). Then, a correction process is performed by multiplying the captured image data items of the individual pixels by the corresponding shading correction values. Correction errors are stored in the area-specific correction-error memory 213 in accordance with a correction state that has been obtained by the sensitivity correction calculation processing unit 141 (step S5).

Then, a process of rectifying sensitivity values is performed by the sensitivity correction-error rectification processing unit 214 using the sensitivity values of the individual areas, which are stored in the area-specific-sensitivity memory 220, (step S7) and the correction errors, which are stored in the area-specific correction-error memory 213, (step S6), thereby obtaining rectified sensitivity values. After that, the shading correction values stored in the correction-value memory 160 are updated using the rectified sensitivity values (step S8).

The process of rectifying the shading correction values is repeatedly performed a plurality of times until appropriate shading correction values are obtained. The accuracy of shading correction values is increased so that it can be considered that the sensitivity values specific to the individual areas coincide with one another with a desired measurement accuracy. Alternatively, in a case in which performance of the process of rectifying the shading correction values one time allows appropriate shading correction values to be obtained, the process of rectifying the shading correction values may be performed only one time.

### 1.5 Description of Processing State Based on Specific Area Setting

Next, the details of a state in which a specific area setting is set for an image capture face and a processing state using the area setting will be described with reference to FIGS. 6 to 8.

Herein, it is supposed that the image capture region 111 of the solid-state image capturing element 110 is divided into eight areas in the horizontal direction and into six areas in the vertical diction as illustrated in FIG. 6, thereby dividing the image capture region 111 into 48 areas in sum. It is supposed that the solid-state image capturing element 110, which is used here, has 1280 pixels in the horizontal direction and 960 pixels in the vertical direction. Accordingly, one area has 160 pixels×160 pixels.

Here, for example, it is supposed that the size of one pixel is, for example, 3.75 square micrometers. In this case, an image picture system has a field of view of 1600 μm in the horizontal direction and 1200 μm in the vertical direction. With this size setting, when the filed of view is divided into eight areas in the horizontal direction and into six areas in the vertical direction as illustrated in FIG. 6, the size of the field of view of each of the areas is 200 square micrometers.

As the reference light source 10, for example, a semiconductor laser that is connected to a fiber having a core radius of 100 μm and that outputs laser light which has a wavelength of 635 nm and whose power is appropriately 3 mW is used. Lenses are provided so that an image of laser light emitted from the end of the fiber of the semiconductor laser is formed at a focal position of the objective lens 21 which is observed by the solid-state image capturing element 110. The field of view of each of the areas in which image capture is performed by the solid-state image capturing element 110 is irradiated with substantially uniform laser light having a diameter of 100 μm. In this case, a transmittance that does not cause saturation of a camera signal is selected as the transmittance of the filter 22.

FIG. 7 illustrates a state in which each of the areas is irradiated with the laser light.

In this example, a scanning process X1 of changing an area that is to be irradiated with the laser light in the order of areas 111a, which is the upper-left area, 111b, 111c, . . . , in the horizontal direction is performed. Image capture signals are read in a state in which each of the areas is irradiated with the laser light, and a sensitivity value of each of the areas is obtained using the image capture signals. In FIG. 7, a state in which the area 111c is irradiated with the laser light is illustrated. Note that, a sensitivity value of one area may be obtained using only image capture signals of one frame. Alternatively, a value that is obtained by adding, to one another, sensitivity values which have been obtained using image capture signals of a predetermined plural number of frames may be used.

Then, when the scanning process X1 for one line has finished, a scanning process X2 for the next line starts. Thereinafter, scanning processes X3, X4, X5, and X6 are sequentially performed, whereby all of the areas are irradiated with the laser light.

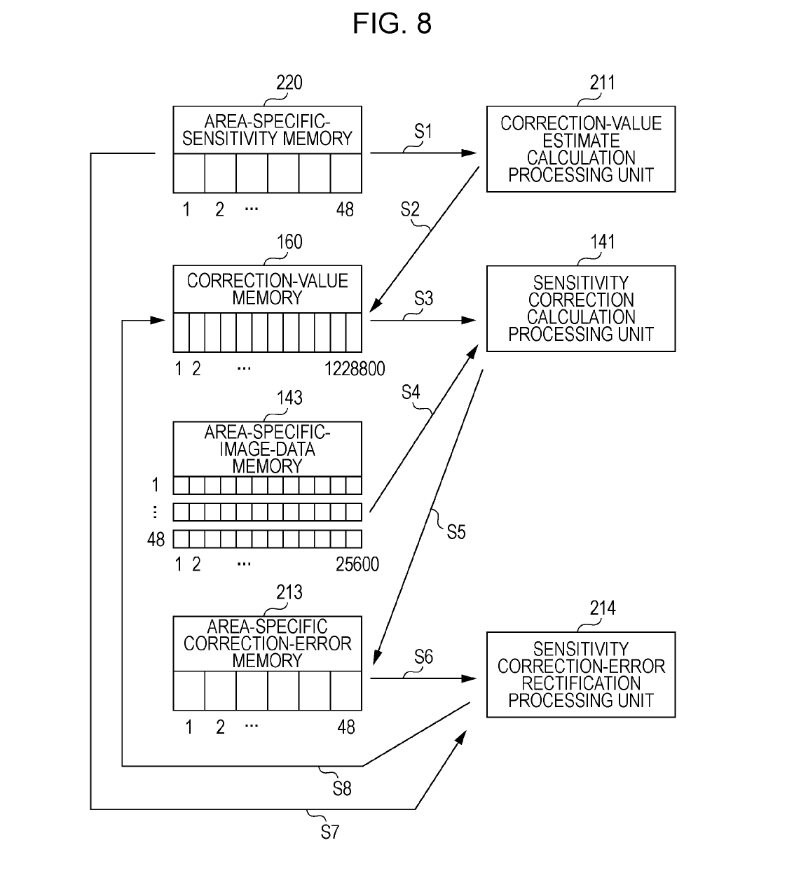

As illustrated in FIG. 8, a value that is obtained by dividing an integral value of the image capture signals for each of the areas by the number of pixels included in the area is stored in a corresponding one of 48 storage regions of the area-specific-sensitivity memory 220. In other words, when the area 111a, which is the first area, is irradiated with the laser light, only image capture signals of the pixels included in the area 111a are extracted. The image capture signals are integrated to obtain an integral value, and the integral value is divided by the number of pixels to obtain a sensitivity value. The sensitivity value is stored in the first storage region of the area-specific-sensitivity memory 220. After the irradiation position at which an area is to be irradiated with the laser light is changed, a process of storing a sensitivity value that has been detected from image capture signals of the pixels included in an area which is being irradiated at the laser light is performed sequentially for all of the areas.

Thereinafter, the processes that have already been described with reference to FIG. 5 are performed. In other words, the correction-value estimate calculation processing unit 211 reads the sensitivity values of the individual areas, which are to be used as average values for the areas (step S1), and the sensitivity estimation process is performed on a pixel-by-pixel basis. Obtained shading correction values are supplied to the correction-value memory 160 having storage regions, the number of storage regions being the numbers of pixels (1280×960), and stored (step S2).

The shading correction values, which are stored in the correction-value memory 160, are supplied to the sensitivity correction calculation processing unit 141 (step S3). An image data item (captured image data items) of the pixels (160 pixels×160 pixels) included in each of the 48 areas is also supplied to the sensitivity correction calculation processing unit 141 (step S4). Then, a correction process is performed by multiplying the captured image data items of the individual pixels by the corresponding shading correction values. Correction errors are stored in the area-specific correction-error memory 213 in accordance with a correction state that has been obtained by the sensitivity correction calculation processing unit 141 (step S5).

Then, a process of rectifying the sensitivity values is performed by the sensitivity correction-error rectification processing unit 214 using the sensitivity values of the individual areas, which are stored in the area-specific-sensitivity memory 220, (step S7) and the correction errors, which are stored in the area-specific correction-error memory 213 (step S6), thereby obtaining rectified sensitivity values. After that, an update process of updating the shading correction values stored in the correction-value memory 160 using the rectified sensitivity values is performed (step S8). The update process in step S8 is repeated a plurality of times, thereby finally obtaining the shading correction values with a high accuracy.

### 1.6 Description of Process of Calculating Sensitivity Values and Shading Correction Values

Next, an example of a process of obtaining sensitivity values and shading correction values for all of the pixels using the sensitivity values of the individual areas will be described with reference to FIGS. 9A to 9D, FIGS. 10A to 10C, and FIG. 11. In FIGS. 9A to 9D, FIGS. 10A to 10C, and FIG. 11, a process of obtaining sensitivity values of the pixels that are disposed in one horizontal direction using the sensitivity values of the areas that are arranged in the horizontal direction is illustrated.

In each of FIGS. 9A to 9D, supposing that the horizontal axis indicates a pixel position and 1280 pixels are provided in one horizontal line, the pixel position ranges from the position of the first pixel to the position of the 1280-th pixel. The vertical axis indicates a level corresponding to a sensitivity value.

Here, in this example, as illustrated in FIG. 9A, the sensitivity values stored in the area-specific-sensitivity memory 220 are values that have been detected on an area-by-area basis. Each of the sensitivity values that have been detected on an area-by-area basis is used as an average value of sensitivity values of the pixels included in a corresponding one of the areas as illustrated in FIG. 9B.

As illustrated in FIG. 9B, the sensitivity values are values that gradually change on an area-by-area basis. Accordingly, when shading correction values are calculated from the sensitivity values without performing any process on the sensitivity values, the shading correction values have large errors. For this reason, as illustrated in FIG. 9C, sensitivity values of the pixels that are positioned at the centers of the individual areas are connected to each other using straight lines in correspondence with the average values of the sensitivity values that have been detected. Sensitivity values at the individual pixel positions are calculated using the sensitivity values that are illustrated on a line graph constituted by the straight lines as illustrated in FIG. 9C.

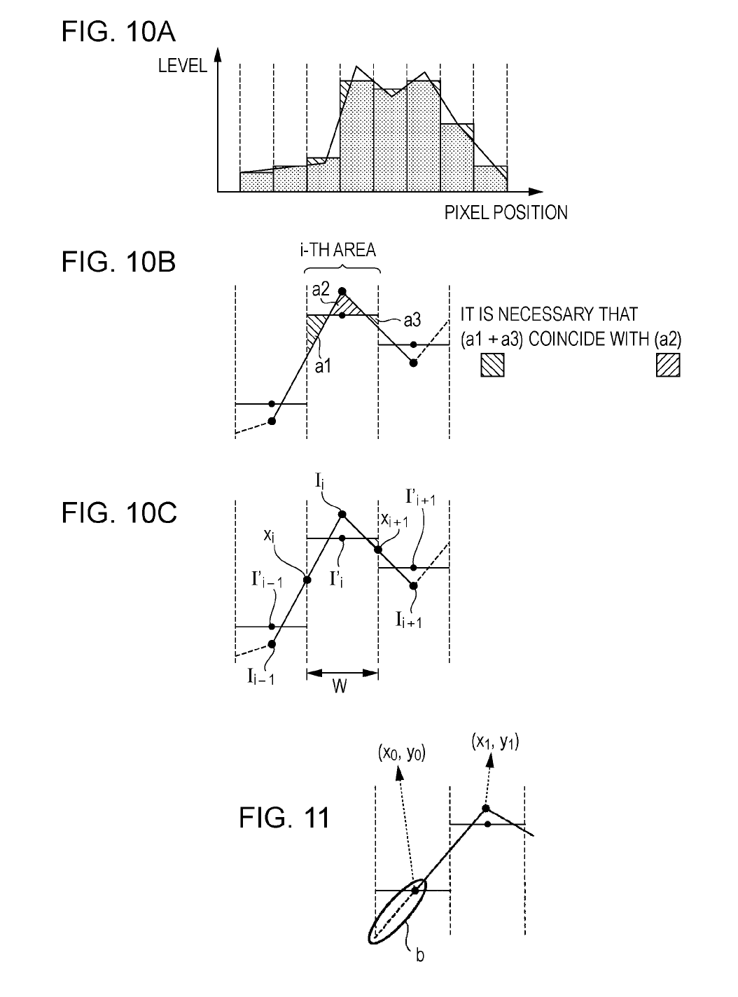

Here, a process of adjusting the sensitivity values that are illustrated on the line graph constituted by the straight lines to appropriate values will be described with reference to FIGS. 10A to 10C.

For example, it is supposed that a sensitivity distribution for the areas is obtained as illustrated in FIG. 10A. In FIG. 10B, one of the areas (herein, the fourth area from the left) illustrated in FIG. 10A and the areas adjacent thereto are enlarged and illustrated.

In a case in which liner interpolation is performed, as illustrated in FIG. 10B, a sensitivity value that is positioned at the center of each of the areas does not coincide with the average value of sensitivity values of the pixels included in the area. The reason for this is that, when liner interpolation is performed, a sensitivity value which is to be positioned at the center of each of the areas is determined so that an area a1+an area a3 is equal to an area a2 in the areas a1, a2, and a3 indicating the differences between the straight lines and the average value illustrated in FIG. 10B.

A calculation process of setting the areas a1, a2, and a3 so that the area a1+the area a3 is equal to the area a2 will be described below.

As illustrated in FIG. 10C, a detected sensitivity value of the central area is denoted by Iᵢ′ and a sensitivity value that is obtained after liner interpolation is performed is denoted by Iᵢ. Furthermore, a detected sensitivity value of the left-adjacent area is denoted by and a sensitivity value that is obtained after liner interpolation is performed is denoted by Iᵢ₋₁. A detected sensitivity value of the right-adjacent area is denoted by and a sensitivity value that is obtained after liner interpolation is performed is denoted by Iᵢ₊₁.

Furthermore, a value xᵢ that is positioned on a straight line indicating the boundary between the central area and the left-adjacent area and a value xᵢ₊₁ that is positioned on a straight line indicating the boundary between the central area and the right-adjacent area are also defined. Moreover, the width of each of the areas is denoted by W.

When the values given above are defined as illustrated FIG. 10C, an integral value of a left half that is obtained after liner interpolation is performed in the central area illustrated in FIG. 10C is represented by Equation 1.

$$\frac{w}{2} \cdot {x}_{i} + \frac{w}{2} \cdot \frac{{I}_{i} - {x}_{i}}{2} \qquad Equation 1$$

An integral value of a right half that is obtained after liner interpolation is performed in the central area illustrated in FIG. 10C is represented by Equation 2.

$$\frac{w}{2} \cdot {x}_{i + 1} + \frac{w}{2} \cdot \frac{{I}_{i} - {x}_{i + 1}}{2} \qquad Equation 2$$

In order that the sum of Equations 1 and 2 be equal to an area which is calculated using the detected sensitivity value of the central area illustrated in FIG. 10C, a below condition indicated by Equation 3 is necessary.

$$( \frac{w}{2} \cdot {x}_{i} + \frac{w}{2} \cdot \frac{{I}_{i} - {x}_{i}}{2} ) + ( \frac{w}{2} \cdot {x}_{i + 1} + \frac{w}{2} \cdot \frac{{I}_{i} - {x}_{i + 1}}{2} ) = w \cdot {I}_{i}^{′} \qquad Equation 3$$

Here, Equation 4 given below is defined.

$${x}_{i + 1} = \frac{{I}_{i} + {I}_{i + 1}}{2} , {x}_{i} = \frac{{I}_{i - 1} + {I}_{i}}{2} \qquad Equation 4$$

When Equation 3 is solved for Iᵢ using Equation 4, Equation 5 given below is obtained.

$${I}_{i} = \frac{4}{3} {I}_{i}^{′} - \frac{1}{6} ( {I}_{i - 1} + {I}_{i + 1} ) \qquad Equation 5$$

Here, the sensitivity values Iᵢ₋₁ and Iᵢ₊₁ are solutions of Equation 5 for the adjacent areas, and are unknown in the initialization state. Accordingly, the sensitivity value Iᵢ is calculated using the sensitivity values I′ᵢ₋₁ and I′ᵢ₊₁ instead of the sensitivity values Iᵢ₋₁ and Iᵢ₊₁ in the initialization state.

Furthermore, in an end area, as illustrated in FIG. 11, a straight line b that is obtained by extending the straight line extending from an area adjacent to the end area is extrapolated.

When eight areas exist in one horizontal direction, calculation is performed for the first to eighth areas in this manner, sensitivity values Iᵢ (where i ranges from one to eight) are temporarily determined.

However, because the sensitivity values Iᵢ that have been calculated are not true sensitivity values Iᵢ that should be obtained, calculation of Equation 5 is performed using the calculated sensitivity values Iᵢ again.

By repeating calculation of Equation 5, the sensitivity values Iᵢ are made to approach true sensitivity values Iᵢ. For example, calculation of Equation 5 is repeated five times. Accordingly, a sensitivity distribution in the horizontal direction for the first to eighth areas is generated. Next, the same calculation is performed for the ninth to sixteenth areas that are located at the next vertical position. Hereinafter, finally, the calculation is performed for the forty-first to forty-eighth areas.

In this manner, sensitivity values of the pixels included in the individual areas in the horizontal direction are determined.

### 1.7 Example of Process of Estimating Sensitivity Values in Column Direction

Next, a process of estimating sensitivity values of the individual pixels that are disposed in the vertical direction (the column direction) will be described with reference to FIGS. 12A to 12C.

In the process illustrated in FIGS. 10A to 10C and FIG. 11, six sensitivity distributions in the horizontal direction are obtained. In other words, six sensitivity distributions corresponding to the scanning processes X1 to X6 that are illustrated in FIG. 7 are obtained. Regarding the horizontal direction, the sensitivity values of the 1280 pixels have been obtained. However, regarding the vertical direction, only six sensitivity values are obtained.

For this reason, as illustrated in FIG. 12A, for example, when a certain pixel column Py in the vertical direction is considered, as illustrated in FIG. 12B, sensitivity values Py1, Py2, . . . , and Py6 of the pixels that are located at the same pixel position in the sensitivity distributions, which have been already calculated, for the individual rows in the horizontal direction are extracted.

Then, the six sensitivity values Py1, Py2, . . . , and Py6 are set as sensitivity values of the six areas that are arranged in the vertical direction as illustrated in FIG. 12C. Calculation of Equation 5, which is described above, is performed using each of the sensitivity values. Also in this case, the calculation is repeated a plurality of times, such as five times. This process is performed for the 1280 pixels in the horizontal direction. Accordingly, sensitivity values of all of the pixels are estimated and calculated.

### 1.8 Example of Process of Rectifying Sensitivity Values

The correction-value estimate calculation processing unit 211 stores, as shading correction values, in the correction-value memory 160, reciprocals of the sensitivity values of the individual pixels that have been obtained as described above. The sensitivity correction calculation processing unit 141 reads an image data item including captured image data items of the individual pixels from a first storage region of an area-specific-image-data memory 143. The sensitivity correction calculation processing unit 141 multiples the captured image data items of the individual pixels by the shading correction values corresponding thereto, and sums the captured image data items of the individual pixels, thereby obtaining a data item. This process of obtaining a data item is repeated until the process is performed for a forty-eighth storage region, thereby obtaining 48 data items. The individual data items are divided by an average value of the data items, thereby obtaining correction errors, and the correction errors are stored in the area-specific correction-error memory 213. Then, the sensitivity values that have been estimated are standardized using an average value of the sensitivity values of all of the pixels or the maximum sensitivity value, and the standardized sensitivity values are determined as sensitivity values of the individual pixels.

When the percentage of a distribution of the correction errors stored in the area-specific correction-error memory 213 is not equal to or lower than 0.5%, the sensitivity correction-error rectification processing unit 214 calculates a product of the first correction error stored in the area-specific correction-error memory 213 and the first sensitivity value stored in the area-specific-sensitivity memory 220, and stores the calculated product as a new sensitivity value in the first storage region of the area-specific-sensitivity memory 220. This process of calculating a product and storing the calculated product as a new sensitivity value is repeated until the process is performed on the forty-eighth sensitivity value. The correction-value estimate calculation processing unit 211 estimates and calculates the shading correction values for all of the pixels from the new sensitivity values stored in the area-specific-sensitivity memory 220 again, and stores the shading correction values in the correction-value memory 160.

The sensitivity correction calculation processing unit 141 generates 48 data items from the shading correction values stored in the correction-value memory 160 and the image data items stored in the area-specific-image-data memory 143. The sensitivity correction calculation processing unit 141 divides the individual data items by an average value of the data items to obtain correction errors, and stores the correction errors in the area-specific correction-error memory 213. The sensitivity correction-error rectification processing unit 214 checks the distribution of the correction errors stored in the area-specific correction-error memory 213 again. A series of calculations is repeated until the percentage of the distribution becomes equal to or lower than 0.5%. A desired measurement accuracy is equal to or lower than 1%. However, because accurate measurement of a sensitivity value is not performed for each of the pixels, a percentage of the distribution of 0.5% is set in order to provide a certain margin. The percentage of the distribution of 0.5% that is determined for the desired measurement accuracy of 1% is only an example. The series of calculations can be repeated until the percentage of the distribution of the correction errors stored in the area-specific correction-error memory 213 becomes equal to or lower than a predetermined value.

Note that the method for rectifying the sensitivity values is not limited thereto. A method may also be used, in which the sensitivity correction-error rectification processing unit 214 reads the correction errors stored in the area-specific correction-error memory 213, in which the sensitivity correction-error rectification processing unit 214 estimates and calculates correction errors corresponding to the individual pixels using calculation that is the same as calculation used in the process of estimating sensitivity values, and in which the sensitivity correction-error rectification processing unit 214 multiples the shading correction values that are stored in the correction-value memory 160 and that correspond to the individual pixels by the correction errors. In this case, the arrow indicating step S7 extends not from the area-specific-sensitivity memory 220 but from the correction-value memory 160.

Using the shading correction values that have been estimated in this manner, the individual pixel values of the image capture signals are corrected by calculation. Accordingly, image capture is performed by the image capturing apparatus 100, and an image signal that is output from the image-signal output terminal 151 is a signal that has been completely subjected to shading correction.

In other words, according to the embodiment of the present invention, using such a light source that can irradiate an area that is one several tenths of the area of the entire image capture region of the solid-state image capturing element with substantially uniform light, shading correction can be performed with a measurement accuracy of 1% or lower. Such a light source can be comparatively easily realized using a laser light source or the like. Accordingly, a high-accuracy beam-profile measuring apparatus capable of performing measurement of a light distribution having a characteristic that the percentage thereof is equal to or lower than 1%, which was difficult measurement in the related art, can be realized. An observing and image-capturing apparatus other than the beam-profile measuring apparatus may also be realized.

Furthermore, the image capturing apparatus 100 can also completely perform shading correction, whereby an image signal that is not influenced by shading can be obtained. Accordingly, an image displayed on the display apparatus 302 is a favorable image that is not influenced by shading.

### 2. Description of Modification Examples

Note that, in the above-described embodiment, an element in which pixels are disposed in a matrix form in the horizontal and vertical directions is applied as a solid-state image capturing element that performs shading correction on image capture signals. However, for example, image capture signals that are supplied from a so-called line sensor in which pixels are linearly arranged only in one-dimensional direction can also be applied to shading correction.

Furthermore, in the relationships between division into areas and a beam that are illustrated in FIG. 7 and so forth, an area setting is set so that a laser light beam emitted from the reference light source enters each of the areas. However, in a case in which it is difficult to reduce a size of a spot of a laser light beam to the size of the areas, an area setting may be set, for example, as illustrated in FIG. 13. In other words, as illustrated in FIG. 13, the scanning process X1 of changing a position at which an area is to be irradiated with a laser light beam on an area-by-area basis may be performed in a state in which the center of a spot of the laser light beam is made to almost coincide with the center of each of the areas. A sensitivity value of each of the areas may be measured.

FIG. 14 illustrates another example of a case in which the size of a spot of a laser light beam is larger than the size of the areas.

In the example illustrated in FIG. 14, when irradiation with a laser light beam is first performed, the center of one large area constituted by the four areas, i.e., the areas 111a, 111b, 111e, and 111f, is irradiated with the laser light beam. Then, outputs from the areas 111a, 111b, 111e, and 111f are added to one another, and one sensitivity value is obtained. After that, a scanning process X1′ of moving the four areas to the areas right-adjacent thereto by one area is performed. Outputs from the next four areas, i.e., the areas 111b, 111c, 111f, and 111g, are added to one another, and one sensitivity value is obtained. In this manner, considering the four areas as one large area, sensitivity values of the individual areas are sequentially obtained in a state in which portions of the large areas overlap each other. Accordingly, also in this manner, a sensitivity value of each of the areas can be detected, and shading correction values can be determined.

Note that, the specific pixel values, a state of division into areas, and examples of calculation of the individual values using the equations in the above-described embodiments are suitable examples. The values and the examples of calculation are not limited thereto.

The present application contains subject matter related to that disclosed in Japanese Priority Patent Application JP 2009-248277 filed in the Japan Patent Office on Oct. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A shading correction method comprising the steps of:
dividing a light receiving region of a solid-state image capturing element, in which pixels including light receiving elements are disposed, into areas;
irradiating each of the division areas with light, which is emitted from a light source serving as a reference, via an image forming optical system so that a size of a spot of the light corresponds to a size of the area;
storing, in an area-specific-sensitivity memory, a sensitivity value of each of the areas that have been irradiated with the light;
calculating shading correction values for all of the pixels of the solid-state image capturing element from the sensitivity values that are stored in the area-specific-sensitivity memory;
storing the calculated shading correction values for all of the pixels in a correction-value memory; and
correcting signals of the individual pixels using the corresponding shading correction values for the pixels that are stored in the correction-value memory, the signals of the individual pixels being obtained using image capture by the solid-state image capturing element.

2. The shading correction method according to claim 1,
wherein straight lines or curves are interpolated between the sensitivity values of the individual areas, which are stored in the area-specific-sensitivity memory, or between the shading correction values that have been obtained using the sensitivity values of the individual areas, and
wherein shading correction values for the individual pixels disposed in the light receiving region of the solid-state image capturing element are estimated on the basis of the straight lines or curves that have been obtained by the interpolation, and stored in the correction-value memory.

3. The shading correction method according to claim 2, wherein calculation of the shading correction values is repeated until a percentage of a distribution of correction errors for the individual areas becomes equal to or lower than a predetermined percentage, the correction errors being stored in the area-specific-sensitivity memory.

4. The shading correction method according to claim 2 or 3, wherein calculation for reducing errors between the straight lines or curves, which have been obtained by the interpolation, is performed once or a plurality of times.

5. The shading correction method according to claim 4, wherein the areas are areas that are obtained by dividing the light receiving region of the solid-state image capturing element in a two-dimensional direction, and shading correction values for all of the pixels in the two-dimensional direction are obtained in the step of calculating shading correction values and stored in the correction-value memory.

6. The shading correction method according to claim 4, wherein the areas are areas that are obtained by dividing the light receiving region of the solid-state image capturing element in a one-dimensional direction, and shading correction values for all of the pixels in the one-dimensional direction are obtained in the step of calculating shading correction values and stored in the correction-value memory.

7. The shading correction method according to claim 5 or 6, wherein each of the areas is formed by superimposing portions of the area and portions of the areas adjacent to the area on each other.

8. A shading-correction-value measuring apparatus comprising:
an image forming optical system configured to irradiate each of areas with light so that a size of a spot of the light corresponds to a size of the area, the areas being obtained by dividing a light receiving region of a solid-state image capturing element in which pixels including light receiving elements are disposed, the light being emitted from a light source serving as a reference;
an irradiation-light movement member configured to move an area that is to be irradiated with light emitted from the light source from one of the areas to another one of the areas;
an area-specific-sensitivity memory configured to store a sensitivity value of each of the areas, which have been irradiated with the light, of the solid-state image capturing element; and
a calculation unit configured to calculate shading correction values for all of the pixels of the solid-state image capturing element from the sensitivity values that are stored in the area-specific-sensitivity memory.

9. An image capturing apparatus comprising:
a solid-state image capturing element in which pixels including light receiving elements are disposed and which is provided so that an optical system which causes image light to enter a light receiving region is disposed in front of the solid-state image capturing element;
a correction-value memory configured to store shading correction values for all of the pixels of the solid-state image capturing element; and
a correction processing unit configured to correct signals of the individual pixels using the shading correction values for the individual pixels that are stored in the correction-value memory, the signals of the individual pixels being obtained using image capture and being output by the solid-state image capturing element,
wherein the shading correction values stored in the correction-value memory are shading correction values for all of the pixels that have been calculated from sensitivity values of individual areas which have been irradiated with the image light, the areas being obtained by dividing the light receiving region of the solid-state image capturing element, each of the division areas being irradiated with the image light, which is emitted from a light source serving as a reference, via the optical system so that a size of a spot of the image light corresponds to a size of the area.

10. A beam-profile measuring apparatus comprising:
a solid-state image capturing element in which pixels including light receiving elements are disposed and which is provided so that an optical system which causes a beam that is a measurement target to enter a light receiving region is disposed in front of the solid-state image capturing element;
a correction-value memory configured to store shading correction values for all of the pixels of the solid-state image capturing element;
a correction processing unit configured to correct signals of the individual pixels using the shading correction values for the individual pixels that are stored in the correction-value memory, the signals of the individual pixels being obtained using image capture and being output by the solid-state image capturing element; and
a beam analysis unit configured to analyse a beam, which is a measurement target, using captured images that have been corrected by the correction processing unit,
wherein the shading correction values stored in the correction-value memory are shading correction values for all of the pixels that have been calculated from sensitivity values of individual areas which have been irradiated with the beam, the areas being obtained by dividing the light receiving region of the solid-state image capturing element, each of the division areas being irradiated with the beam, which is emitted from a light source serving as a reference, via the optical system so that a size of a spot of the beam corresponds to a size of the area.
